(19) United States
(12) Patent Application Publication
(10) Pub. No.: US 2004/0042650 A1
(43) Pub. Date: Mar. 4, 2004

(54) Binary optical neural network classifiers for pattern recognition

(75) Inventors: David L. Ii, Owego, NY (US); Elliott D. Reitz, II, Bradenton, FL (US); Dennis A. Tillotson, Glen Aubrey, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/231,853

(22) Filed: Aug. 30, 2002

(51) Int. Cl. G06K 9/62

(52) U.S. Cl. 382/158

(57) ABSTRACT

The present invention recites a method and computer program product for determining if an input pattern is a member of an associated class. Data is extracted from a plurality of preselected features within the input pattern, and a numerical feature value for each feature is determined from the extracted feature data. A contribution value for each feature value is calculated via a common transfer function. Predetermined weights are applied to each of the contribution values. The weighted contribution values from the plurality of features are summed, and a mathematical function is applied to the sum of the contribution values to determine a classification result.

### BACKGROUND OF THE INVENTION

1. Technical Field

The invention relates to a pattern recognition device or classifier. Image processing systems often contain pattern recognition devices (classifiers).

2. Description of the Prior Art

Pattern recognition systems, loosely defined, are systems capable of distinguishing between various classes of real world stimuli according to their divergent characteristics. A number of applications require pattern recognition systems, which allow a system to deal with unrefined data without significant human intervention. By way of example, a pattern recognition system may attempt to classify individual letters to reduce a handwritten document to electronic text. Alternatively, the system may classify spoken utterances to allow verbal commands to be received at a computer console.

Obtaining reliable results within a pattern recognition application, however, requires careful system design. Specifically, in designing a pattern classifier, it is necessary to take great care in the choice of characteristics, or features, that will be considered by the system in the classification process. Unless a suitable feature set is selected, the classifier will be unable to distinguish between the output classes with sufficient precision. Even where features effective in distinguishing between output classes are utilized by the system, the presence of features ill-suited to the classification problem can result in decreased accuracy. Determining which features are necessary and which are misleading requires a great deal of experimentation. A classifier capable of ignoring non-discriminative features would greatly reduce the time and money consumed by this process.

### STATEMENT OF THE INVENTION

In accordance with one aspect of the invention, a method for determining if an input pattern is a member of an associated class is disclosed. Data is extracted from a plurality of preselected features within the input pattern, and a numerical feature value for each feature is determined from the extracted feature data. A contribution value for each feature value is calculated via a common transfer function. Predetermined weights are applied to each of the contribution values. The weighted contribution values from the plurality of features are summed, and a mathematical function is applied to the sum of the contribution values to determine a classification result.

In accordance with another aspect of the present invention, a computer program product operative in a data processing system is disclosed for use in determining if an input pattern is a member of an associated class. First, a feature extraction stage extracts data from a plurality of preselected features within the input pattern and determines a numerical feature value for each feature from the extracted feature data. Then, a hidden layer calculates a contribution value for each feature value via a common transfer function and applies predetermined weights to each of the contribution values. Finally, an output layer sums the weighted contribution values from the plurality of features and applies a mathematical function to the sum of the contribution values to determine a classification result.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is an illustration of an exemplary neural network utilized for pattern recognition;

FIG. 2 illustrates a pattern recognition system incorporating a classifier in accordance with the present invention;

FIG. 3 illustrates the classification portion of the claimed classifier;

FIG. 4 a flow diagram illustrating the training of an example classification system;

### DETAILED DESCRIPTION OF THE INVENTION

In accordance with the present invention, a method for classifying an input pattern via a binary optimal neural network classification system is described. The classification system may be applied to any pattern recognition task, including, for example, optical character recognition (OCR), speech translation, and image analysis in medical, military, and industrial applications.

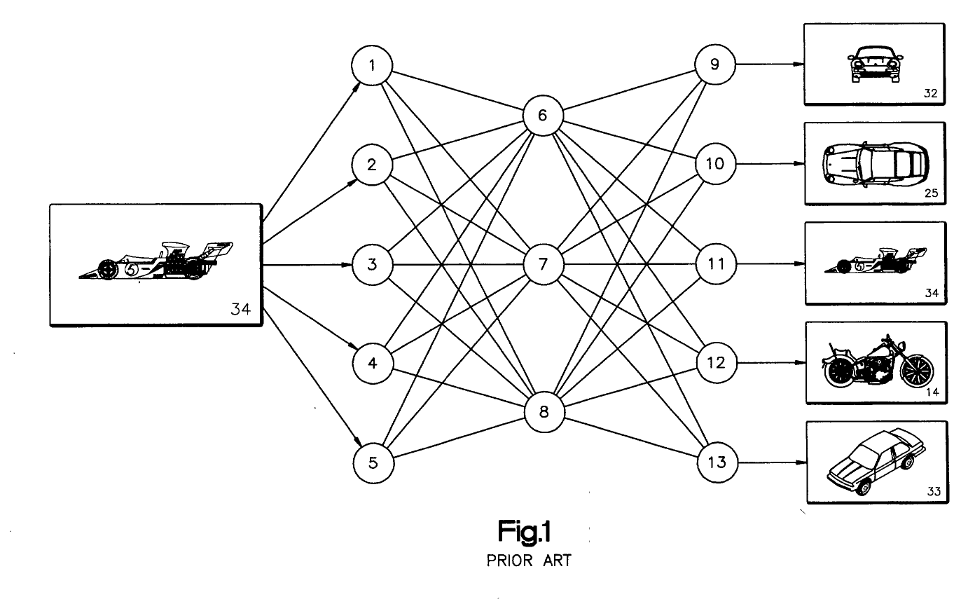

FIG. 1 illustrates a neural network which might be used in a pattern recognition task. The illustrated neural network is a three-layer back-propagation neural network used in a pattern classification system. It should be noted here, that the neural network illustrated in FIG. 1 is a simple example solely for the purposes of illustration. Any non-trivial application involving a neural network, including pattern classification, would require a network with many more nodes in each layer. Also, additional hidden layers might be required.

In the illustrated example, an input layer comprises five input nodes, 1-5. A node, generally speaking, is a processing unit of a neural network. A node may receive multiple inputs from prior layers which it processes according to an internal formula. The output of this processing may be provided to multiple other nodes in subsequent layers. The functioning of nodes within a neural network is designed to mimic the function of neurons within a human brain.

Each of the five input nodes 1-5 receive input signals with values relating to features of an input pattern. By way of example, the signal values could relate to the portion of an image within a particular range of grayscale brightness. Alternatively, the signal values could relate to the average frequency of a audio signal over a particular segment of a recording. Preferably, a large number of input nodes will be used, receiving signal values derived from a variety of pattern features.

Each input node sends a signal to each of three intermediate nodes 6-8 in the hidden layer. The value represented by each signal will be based upon the value of the signal received at the input node. It will be appreciated, of course, that in practice, a classification neural network may have a number of hidden layers, depending on the nature of the classification task.

Each connection between nodes of different layers is characterized by an individual weight. These weights are established during the training of the neural network. The value of the signal provided to the hidden layer by the input nodes is derived by multiplying the value of the original input signal at the input node by the weight of the connection between the input node and the intermediate node. Thus, each intermediate node receives a signal from each of the input nodes, but due to the individualized weight of each connection, each intermediate node receives a signal of different value from each input node. For example, assume that the input signal at node 1 is of a value of 5 and the weight of the connection between node 1 and nodes 6-8 are 0.6, 0.2, and 0.4 respectively. The signals passed from node 1 to the intermediate nodes 6-8 will have values of 3, 1, and 2.

Each intermediate node 6-8 sums the weighted input signals it receives. This input sum may include a constant bias input at each node. The sum of the inputs is provided into an transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes 6-8 pass a signal with the computed output value to each of the nodes 9-13 of the output layer. An individual intermediate node (i.e. 7) will send the same output signal to each of the output nodes 9-13, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node represents the probability that a given input sample belongs to the associated class. In the example system, the class with the highest associated probability is selected, so long as the probability exceeds a predetermined threshold value. The value represented by the output signal is retained as a confidence value of the classification.

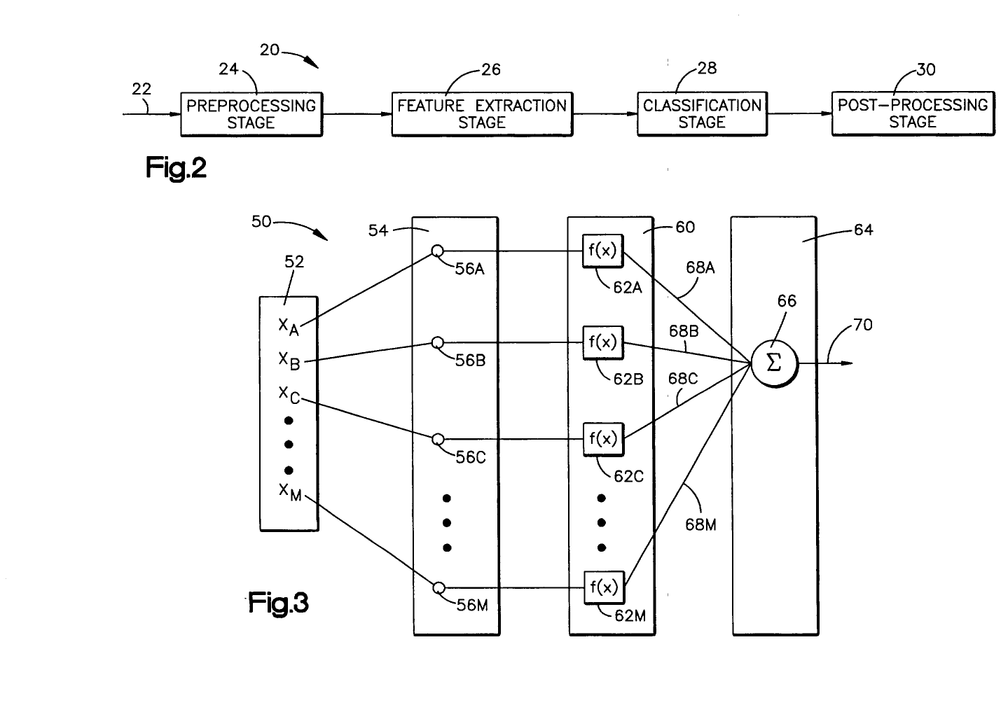

FIG. 2 illustrates a pattern recognition system 20 incorporating a binary classifier in accordance with the present invention. Prior to reaching the classifier, an input pattern is obtained and extraneous portions of the image are dropped. The system identifies and isolates portions of the pattern that are necessary for further processing. By way of example, in an image recognition system, the system might locate candidate objects and crop extraneous portions of the picture. In a speech recognition system, the preprocessor might identify and isolate individual words or syllables.

A selected pattern segment 22 is inputted into a preprocessing stage 24, where various representations of the pattern segment are produced to facilitate feature extraction. By way of example, image data might be normalized and reduced in scale. Audio data might be filtered to reduce noise levels.

In the preferred embodiment of a postal indicia recognition system, the system locates any stamps within the envelope image. The image is segmented to isolate the stamps into separate images and extraneous portions of the stamp images are cropped. Any rotation of the stamp image is corrected to a standard orientation. The preprocessing stage 24 then reduces the image size to facilitate feature extraction.

The preprocessed pattern segment is then passed to a feature extraction stage 26. The feature extraction stage 26 analyzes preselected features of the pattern. The selected features can be literally any values derived from the pattern that vary sufficiently among the various output classes to serve as a basis for discriminating between them. Numerical data extracted from the features can be conceived for computational purposes as a feature vector, with each element of the vector representing a value derived from one feature within the pattern. Features can be selected by any reasonable method, but typically, appropriate features will be selected by experimentation. In the preferred embodiment of a postal indicia recognition system, a thirty-two element feature vector is used, including sixteen histogram feature values, and sixteen “Scaled 16” feature values.

A scanned grayscale image consists of a number of individual pixels, each possessing an individual level of brightness, or grayscale value. The histogram portion of the feature vector focuses on the grayscale value of the individual pixels within the image. Each of the sixteen histogram variables represents a range of grayscale values. The values for the histogram feature variables are derived from a count of the number of pixels within the image having a grayscale value within each range. By way of example, the first histogram feature variable might represent the number of pixels falling within the lightest sixteenth of the range all possible grayscale values.

The “Scaled 16” variables represent the average grayscale values of the pixels within sixteen preselected areas of the image. By way of example, the sixteen areas may be defined by a 4×4 equally spaced grid superimposed across the image. Thus, the first variable would represent the average or summed value of the pixels within the upper left region of the grid.

The extracted feature vector is then inputted into a classification stage 28. Unlike prior art classifiers, the claimed classifier does not select a class by distinguishing between a plurality of classes. Instead, the classifier produces a binary result for its associated class; either the input feature data meets the threshold for class membership or it does not. Typically, the classifier outputs only this binary result, although the value used in the threshold calculation can be retained and used as a rough confidence measurement.

Accordingly, in many applications, a number of classifiers will be used, each representing an associated output class. In such cases, a method of prioritizing the classifier outputs to select a single classification result is necessary. This can be accomplished in a number of ways, most notably by sequencing the classifiers and accepting the first positive output or by retaining the values used in the threshold comparison for comparison.

The classification result is then passed to a post-processing stage 30. The post-processing stage 30 receives the classification from the classifier and applies it to a real world task, such as transcribing recorded words into'digital text or highlighting abnormal structures in a medical x-ray. In multi-class applications, a number of classifiers will send outputs to the post processing stage. In such a case, the post-processing stage 30 will select the appropriate classification output and apply these results to the post-processing task.

In the preferred embodiment, classification results will be received sequentially from the various classifiers. The post-processing stage 30 will adopt the associated class from the first classifier to return a positive classification result as the system output. Upon receiving a positive result, the post-processing stage will instruct the control stage to cease activating classifiers. The classification result for the postal indicia is used to maintain a total of the incoming postage. Other tasks for the post-processing portion should be apparent to one skilled in the art.

FIG. 3 illustrates the classification portion 50 of the claimed classifier. As discussed above, the neural network contained in the classification portion is typically simulated as part of a computer program. It would be possible, of course, to construct the network as a traditional neural network with a number of parallel processors. Such a network would be encompassed by the spirit of this invention.

The classification portion 50 receives data pertaining to features within the pattern segment in the form of a feature vector 52. Each element within the feature vector contains a feature value for one feature. The input layer 54 of the network includes a number of nodes 56A-56M equal to the number of elements in the feature vector. Each node receives a corresponding feature value from the feature vector 52. The input nodes pass these values unaltered to the hidden layer 60.

The hidden layer 60 contains a number of nodes equal to the number of input nodes 56A-56M. Each of these intermediate nodes 62A-62M, receive a value from a corresponding input node (e.g., 56B). The value received at the intermediate node (e.g., 62B) is subjected to a transfer function to calculate an output to the output layer. This output value, for each of reference, will be referred to as a contribution value. This transfer function will typically be a radial basis function, with the maximum contribution of the function clipped at a number of standard deviations from the mean. It should be noted that the transfer functions will require training data from a set of known samples for the class, including statistical parameters for each feature vector element.

A number of basis functions are available for use as transfer functions in the claimed classifier. The simplest of these is an impulse function over a predetermined range. In such a function, the contribution value takes on a value of one when the associated feature value falls within a predetermined range and takes on a value of zero when the associated feature value falls outside a predetermined range. This range can be selected in a number of ways. In the example embodiment, the range for each feature is bounded by the minimum and maximum values obtained for that feature during training. Alternatively, the range could be determined by parameters known by experimentation, bounded at a set number of standard deviations around the mean, or merely the interquartile range. Other methods of setting an appropriate range should be apparent to one skilled in the art.

A second type of function which can be used in the classifier is a first order distance function. In a first order distance function, the contribution value is calculated by taking the absolute value of the difference between the feature value and a calculated mean value of this feature from the training set and dividing this result by a calculated standard deviation from the training samples (i.e. |x−μᵢ|/σᵢ). In this case, the contribution value will be equal to the distance, in standard deviations, each feature value falls from the calculated mean value for that feature in the training samples. This value is most useful when it is subjected to non-linear clipping to prevent any one element from influencing the sum unduly. Clipping values may be obtained through experimentation. In the preferred embodiment, a maximum value of 7 for the contribution value works well.

Other derivations of the distance formula are also suitable for use with the claimed classifier. A transfer function using the square of the distance function described above can be used to eliminate the need for the absolute value function. On a similar note, an exponential function bounded by 0 and 1 can be used to avoid the need for clipping. Finally, statistical techniques can be used to transform the distance function into a value expressing the likelihood that the extracted feature value came from a distribution possessing the characteristics derived from the training values of that feature. Such a likelihood is directly useful in obtaining a confidence value for the calculation.

After the contribution values have been obtained, they are passed to the output layer 64. Prior to being received at the output node 66, each value is multiplied by a weight (e.g. 68B), determined in a training mode prior to operation of the classifier. The weights for each contribution value are independently determined according to the individual training statistics of the associated feature.

Focusing on the specific functions listed above, when the impulse function is used, the contribution values are given an equal weight of one. Thus, the value inputted to the output node from each intermediate node will be either one or zero. For the distance function or any of its variations, the weight will be equal to the multiplicative inverse of the expectation value of the function itself. Thus, for the distance function, each weight would be 1/[E(|x−μᵢ|/σᵢ)].

The weighted values are received at the output node where they are summed to produce an h-value for the associated class. A binary classification result 70 is achieved by applying a mathematical function to the h-value. In a preferred embodiment, the mathematical function is a step function. Depending on the basis function used, the function can be responsive to either higher or lower values of the h-value. Either way, the output node will output either one or zero, as a function of the h-value.

It should be noted here that the mathematical function used at the output node should not be adversely affected by non-discriminant features. Ideally, the classifier processes the data from each feature separately, and merely sums the results at the end. Accordingly, each feature will contribute any discriminative power it has to the determination. The result is simple; bad features do not affect the operation of the classifier. To the extent that a feature is at all useful in discriminating between output classes, it adds to the accuracy of the classification.

A binary classification system represents only a single output class. In other words, at the end of the classification process, the classifier will return only a binary classification result. Either the inputted pattern sample is a member of the represented output class, or it is not. Perhaps the greatest advantage of a binary system, however, is its ability to compute a meaningful confidence value for the classification when applied with an appropriate transfer function. Traditional multi-class classification techniques, such as Bayesian classification, lack the capacity to produce a meaningful value.

In a single class application, a single binary classifier can provide the desired result. Thus, the classifier can be useful by itself in a system where a binary response is desired, such as accepting or rejecting a mechanical part, or determining if a structure is natural or man-made. The classifier can also be applied to multi-class applications with relative ease. Since each classifier produces a meaningful confidence value, comparisons between a number of classifiers or to a predetermined threshold will produce an accurate classification result. Accordingly, multiple classifiers could be cascaded with the system accepting the result with the highest associated confidence value or by establishing an order of priority among the classifiers. In a preferred embodiment, the classifiers are activated sequentially, and the first positive result is accepted.

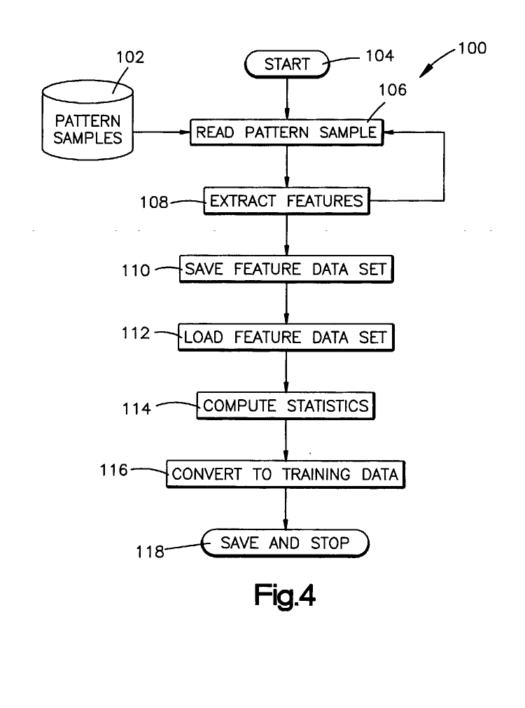

FIG. 4 is a flow diagram illustrating the operation of a computer program 100 used to train a pattern recognition classifier via computer software. A number of pattern samples 102 are obtained. The number of pattern samples necessary for training varies with the application and the selected features. While the use of too few samples can result in poor classifier discrimination, the use of too many samples can also be problematic, as it can take too long to process the training data without a significant gain in performance.

The actual training process begins at step 104 and proceeds to step 106. At step 106, the program retrieves a pattern sample from memory. The process then proceeds to step 108, where the pattern sample is converted into a feature vector input similar to those a classifier would see in normal run-time operation. After each sample feature vector is extracted, the results are stored in memory, and the process returns to step 106. After all of the samples are analyzed, the process proceeds to step 110, where the feature vectors are saved to memory as a set.

The actual computation of the training data begins in step 112, where the saved feature vector set is loaded from memory. After retrieving the feature vector set, the process progresses to step 114. At step 114, the program calculates statistics, such as the mean and standard deviation of the feature variables for the class represented by the classifier. Intervariable statistics may also be calculated, including a covariance matrix of the sample set. The process then advances to step 116 where it computes the training data. At this step in the example embodiment, an inverse covariance matrix is calculated, as well as any fixed value terms needed for the classification process. After these calculations are performed, the process proceeds to step 118 where the training parameters are stored in memory and the training process ends.

It will be understood that the above description of the present invention is susceptible to various modifications, changes and adaptations, and the same are intended to be comprehended within the meaning and range of equivalents of the appended claims. As one example, transfer functions, features, and pattern types differing from those herein described may be used with the individual classifiers without departing from the spirit of the invention.

Having described the invention, we claim:

1. A method for determining if an input pattern is a member of an associated class, comprising:
extracting data from a plurality of preselected features within the input pattern;
determining a numerical feature value for each feature from the extracted feature data;
calculating a contribution value for each feature value via a common transfer function;
applying predetermined weights to each of the contribution values;
summing the weighted contribution values from the plurality of features; and
applying a mathematical function to the sum of the contribution values to determine a binary classification result.

2. A method as set forth in claim 1, wherein the common transfer function includes an impulse function, such that a contribution value takes on a value of one when an associated feature value is within a predetermined range and takes on a value of zero when the associated feature value falls outside the predetermined range.

3. A method as set forth in claim 1, wherein the common transfer function includes a radial distance function, such that the value of the function is equal to the absolute value of the difference between the feature value and a calculated mean feature value divided by a calculated standard deviation.

4. A method as set forth in claim 1, wherein the input pattern is a scanned image.

5. A method as set forth in claim 4, wherein the associated class represents a variety of postal indicia.

6. A method as set forth in claim 4, wherein the associated class represents an alphanumeric character.

7. A computer program product operative in a data processing system for use in determining if an input pattern is a member of an associated class, said computer program product comprising:
a feature extraction stage that extracts data from a plurality of preselected features within the input pattern and determines a numerical feature value for each feature from the extracted feature data;
a hidden layer that calculates a contribution value for each feature value via a common transfer function and applies predetermined weights to each of the contribution values; and
an output layer that sums the weighted contribution values from the plurality of features and applies a mathematical function to the sum of the contribution values to determine a binary classification result.

8. A computer program product as set forth in claim 7, wherein the common transfer function in the hidden layer includes an impulse function, such that a contribution value takes on a value of one when an associated feature value is within a predetermined range and takes on a value of zero when the associated feature value falls outside the predetermined range.

9. A computer program product as set forth in claim 7, wherein the common transfer function in the hidden layer includes a radial basis function, such that the value of the function is equal to the absolute value of the difference between the feature value and a calculated mean feature value divided by a calculated standard deviation.

10. A computer program product as set forth in claim 7, wherein the input pattern is a scanned image.

11. A computer program product as set forth in claim 10, wherein the associated class represents a variety of postal indicia.

12. A computer program product as set forth in claim 10, wherein the associated class represents an alphanumeric character.
